(19) United States
(12) Patent Application Publication
(10) Pub. No.: US 2022/0215645 A1
(43) Pub. Date: Jul. 7, 2022

(54) Computer Vision Systems and Methods for Determining Roof Conditions from Imagery Using Segmentation Networks

(71) Applicant: Insurance Services Office, Inc., Jersey City, NJ (US)

(72) Inventors: Dean Lebaron, Pleasant Grove, UT (US); Jose David Aguilera, South Jordan, UT (US); Bryce Zachary Porter, Lehi, UT (US); Francisco Rivas, Móstoles (ES)

(73) Assignee: Insurance Services Office, Inc., Jersey City, NJ (US)

(21) Appl. No.: 17/569,077

(22) Filed: Jan. 5, 2022

Related U.S. Application Data
(60) Provisional application No. 63/133,863, filed on Jan. 5, 2021.

(51) Int. Cl. G06V 10/26; G06V 10/25; G06V 10/82; G06T 7/11; G06T 7/12

(52) U.S. Cl. CPC G06V 10/26; G06V 10/25; G06T 2207/30184; G06T 7/11; G06T 7/12; G06V 10/82

(57) ABSTRACT

Computer vision systems and methods for determining roof conditions from imagery using segmentation networks are provided. The system obtains at least one image from an image database having a roof structure present therein, and determines a footprint of the roof structure using a neural network. Based on segmentation processing by the neural network, the system generates a single channel image that maps each pixel in the at least one image to a binary classification indicative of whether each pixel is or is not representative of a roof structure and executes a contour extraction algorithm on the single channel image to determine the footprint of the roof structure. Then, the system determines condition features of the roof structure using the neural network, defines roof structure condition features, detects the roof structure condition features via segmentation, and generates a single channel image that maps each pixel in the obtained image to a condition label indicative of a defined roof structure condition feature. A roof structure condition feature report indicative of condition features of the roof structure and their respective contributions toward the total roof structure can be generated.

### RELATED APPLICATIONS

The present application claims priority to U.S. Provisional Application Ser. No. 63/133,863 filed on Jan. 5, 2021, the entire disclosure of which is expressly incorporated herein by reference.

### BACKGROUND

### Technical Field

The present disclosure relates generally to the field of computer modeling of structures. More particularly, the present disclosure relates to computer vision systems and methods for determining roof conditions from imagery using segmentation networks.

### Related Art

Accurate and rapid identification and depiction of objects from digital images (e.g., aerial images, satellite images, etc.) is increasingly important for a variety of applications. For example, information related to various features of buildings, such as roofs, walls, doors, etc., is often used by construction professionals to specify materials and associated costs for both newly-constructed buildings, as well as for replacing and upgrading existing structures. Further, in the insurance industry, accurate information about structures may be used to determine the proper costs for insuring buildings/structures. For example, surface areas and conditions of roof structures are valuable sources of information.

Various software systems have been implemented to process ground images, aerial images and/or overlapping image content of an aerial image pair to generate a three-dimensional (3D) model of a building present in the images and/or a 3D model of the structures thereof (e.g., a roof structure). However, these systems can be computationally expensive and have drawbacks, such as missing camera parameter information associated with each ground and/or aerial image and an inability to provide a higher resolution estimate of a position of each aerial image (where the aerial images overlap) to provide a smooth transition for display. Moreover, such systems often require manual inspection of surfaces of the buildings and structures thereof by humans in order to generate accurate models of structures. As such, the ability to determine surface areas and conditions of roof structures, as well as generate a report of such attributes, without first performing manual inspection of the surfaces of the roof structure, is a powerful tool.

Thus, what would be desirable is a system that automatically and efficiently determines roof conditions from imagery and generates reports of such attributes without requiring manual inspection of the roof structure. Accordingly, the computer vision systems and methods disclosed herein solve these and other needs.

### SUMMARY

The present disclosure relates to computer vision systems and methods for determining roof conditions from imagery using segmentation networks. The system obtains at least one image from an image database having a roof structure present therein. The system receives a geospatial region of interest (ROI), an address, or georeferenced coordinates specified by a user and obtains at least one image associated with the geospatial ROI from the image database. Then, the system determines a footprint of the roof structure using a neural network. Based on segmentation processing by the neural network, the system generates a single channel image that maps each pixel in the at least one image to a binary classification indicative of whether each pixel is or is not representative of a roof structure and executes a contour extraction algorithm on the single channel image to determine the footprint of the roof structure. Then, the system determines condition features of the roof structure using the neural network. The system defines roof structure condition features (e.g., discoloration, missing material, structural damage, a tarp, debris, an anomaly, and a patch and/or repair), utilizes the neural network to detect the roof structure condition features via segmentation, and generates a single channel image that maps each pixel in the obtained image to a condition label indicative of a defined roof structure condition feature. The system generates a roof structure condition feature report indicative of condition features of the roof structure and their respective contributions toward (percentages of composition of) the total roof structure.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a flowchart illustrating step 52 of FIG. 2 in greater detail;

FIG. 4 is a diagram illustrating step 54 of FIG. 2 in greater detail;

FIG. 5 is a flowchart illustrating step 56 of FIG. 2 in greater detail;

FIG. 6 is a flowchart illustrating step 58 of FIG. 2 in greater detail;

FIG. 7 is a diagram illustrating an intermediate roof condition feature report;

FIG. 8 is a diagram illustrating a graphical roof condition feature report; and

FIG. 9 is a diagram illustrating another embodiment of the system of the present disclosure.

### DETAILED DESCRIPTION

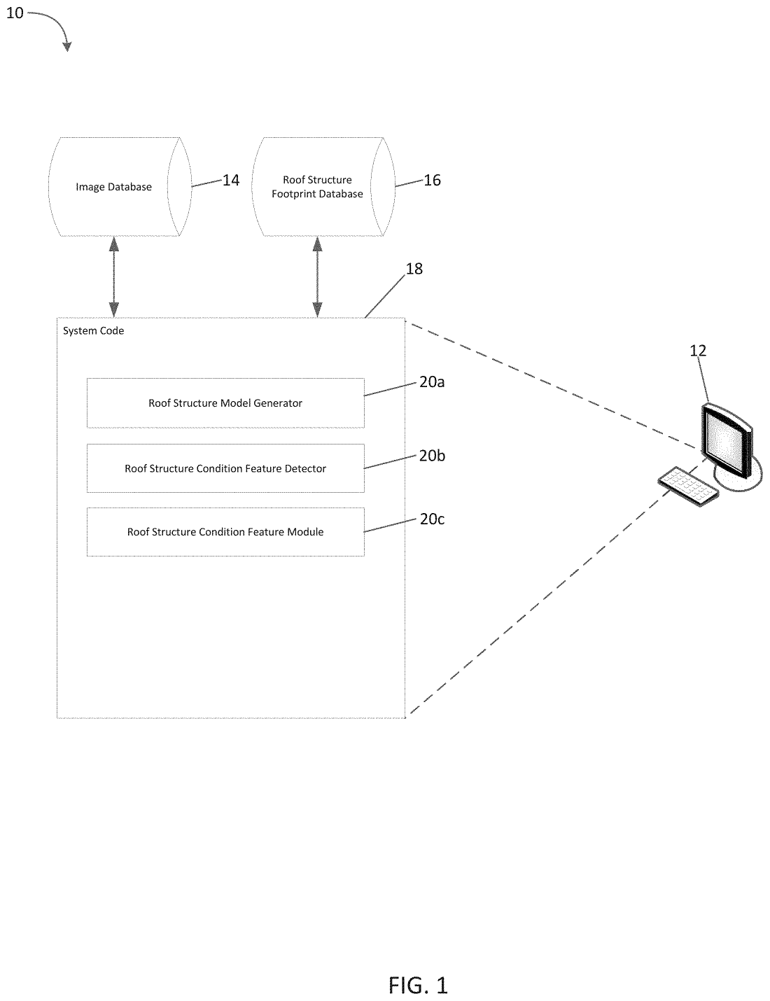

The present disclosure relates to systems and methods for determining roof conditions from imagery using segmentation networks, as described in detail below in connection with FIGS. 1-9.

Turning to the drawings, FIG. 1 is a diagram illustrating an embodiment of the system 10 of the present disclosure. The system 10 could be embodied as a central processing unit 12 (processor) in communication with an image database 14 and/or a roof structure footprint database 16. The processor 12 could include, but is not limited to, a computer system, a server, a personal computer, a cloud computing device, a smart phone, or any other suitable device programmed to carry out the processes disclosed herein. The system 10 could generate at least one roof structure footprint based on a structure present in at least one image obtained from the image database 14. Alternatively, as discussed below, the system 10 could retrieve at least one stored roof structure footprint from the roof structure footprint database 16.

The image database 14 could include digital images and/or digital image datasets comprising ground images, aerial images, satellite images, etc. Further, the datasets could include, but are not limited to, images of residential and commercial buildings. The database 16 could store one or more three-dimensional representations of an imaged location (including structures at the location), such as point clouds, LiDAR files, etc., and the system could operate with such three-dimensional representations. As such, by the terms “image” and “imagery” as used herein, it is meant not only optical imagery (including aerial and satellite imagery), but also three-dimensional imagery and computer-generated imagery, including, but not limited to, LiDAR, point clouds, three-dimensional images, etc. The processor 12 executes system code 18 which determines conditions of a roof structure using a segmentation network based on at least one image obtained from the image database 14 having a structure and corresponding roof structure present therein.

The system 10 includes system code 18 (non-transitory, computer-readable instructions) stored on a computer-readable medium and executable by the hardware processor 12 or one or more computer systems. The code 18 could include various custom-written software modules that carry out the steps/processes discussed herein, and could include, but is not limited to, a roof structure model generator 20a, a roof structure condition feature detector 20b, and a roof structure condition feature module 20c. The code 18 could be programmed using any suitable programming languages including, but not limited to, C, C++, C#, Java, Python or any other suitable language. Additionally, the code 18 could be distributed across multiple computer systems in communication with each other over a communications network, and/or stored and executed on a cloud computing platform and remotely accessed by a computer system in communication with the cloud platform. The code 18 could communicate with the image database 14 and/or the roof structure footprint database 16, which could be stored on the same computer system as the code 18, or on one or more other computer systems in communication with the code 18.

Still further, the system 10 could be embodied as a customized hardware component such as a field-programmable gate array (“FPGA”), application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

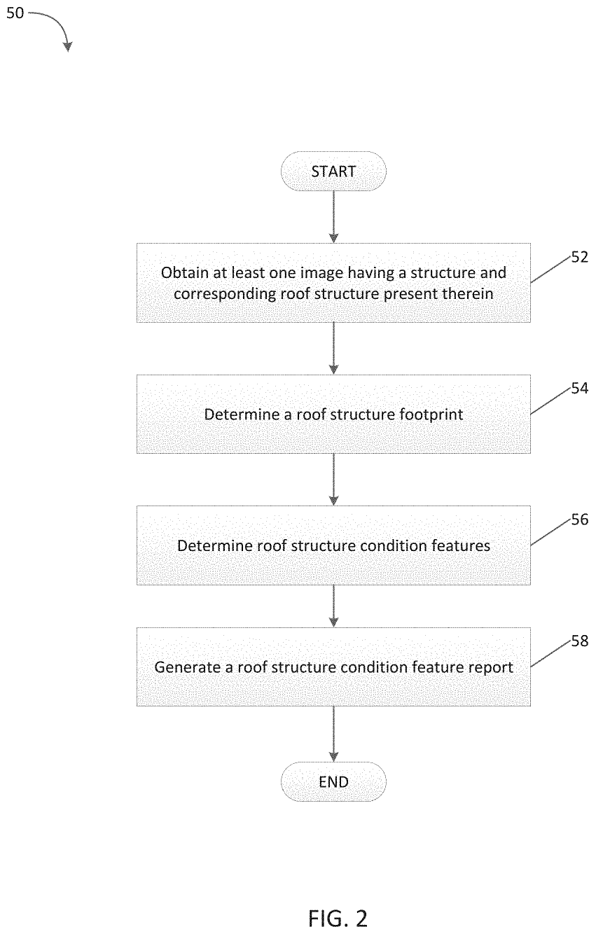

FIG. 2 is a flowchart illustrating overall processing steps 50 carried out by the system 10 of the present disclosure. Beginning in step 52, the system 10 obtains at least one image from the image database 14 having a structure and corresponding roof structure present therein. In step 54, the system 10 determines a footprint of the roof structure using a neural network. Then, in step 56, the system 10 determines condition features of the roof structure using the neural network. In step 58, the system 10 generates a roof structure condition feature report indicative of condition features of the roof structure (e.g., discoloration, missing material, structural damage, a tarp, debris, an anomaly, and a patch and/or repair) and their respective contributions toward (percentages of composition of) the total roof structure.

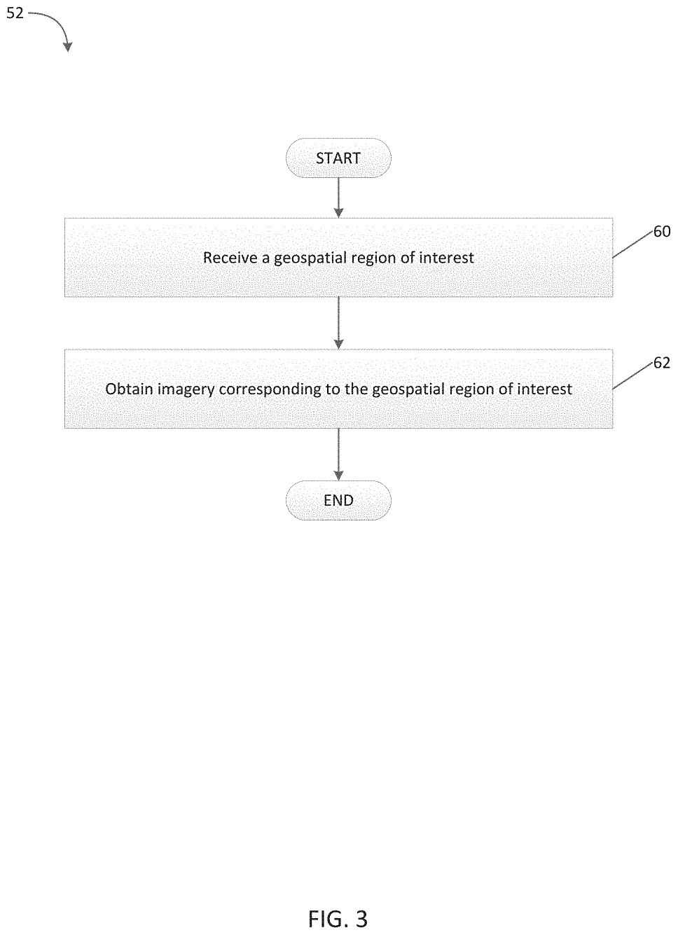

FIG. 3 is a flowchart illustrating step 52 of FIG. 2 in greater detail. Beginning in step 60, the system 10 receives a geospatial region of interest (ROI) specified by a user. For example, a user can input latitude and longitude coordinates of an ROI. Alternatively, a user can input an address of a desired property or structure, georeferenced coordinates, and/or a world point of an ROI. The geospatial ROI can be represented by a generic polygon enclosing a geocoding point indicative of the address or the world point. The region can be of interest to the user because of one or more structures present in the region. A property parcel included within the ROI can be selected based on the geocoding point. As discussed in further detail below, a deep learning neural network can be applied over the area of the parcel to detect a structure or a plurality of structures situated thereon.

The geospatial ROI can also be represented as a polygon bounded by latitude and longitude coordinates. In a first example, the bound can be a rectangle or any other shape centered on a postal address. In a second example, the bound can be determined from survey data of property parcel boundaries. In a third example, the bound can be determined from a selection of the user (e.g., in a geospatial mapping interface). Those skilled in the art would understand that other methods can be used to determine the bound of the polygon. The ROI may be represented in any computer format, such as, for example, well-known text (“WKT”) data, TeX data, HTML data, XML data, etc. For example, a WKT polygon can comprise one or more computed independent world areas based on the detected structure in the parcel.

In step 62, after the user inputs the geospatial ROI, the system 10 obtains at least one image associated with the geospatial ROI from the image database 14. As mentioned above, the images can be digital images such as aerial images, satellite images, etc. However, those skilled in the art would understand that any type of image captured by any type of image capture source. For example, the aerial images can be captured by image capture sources including, but not limited to, a plane, a helicopter, a paraglider, a satellite, or an unmanned aerial vehicle (UAV). It should be understood that multiple images can overlap all or a portion of the geospatial ROI and that the images can be orthorectified and/or modified if necessary.

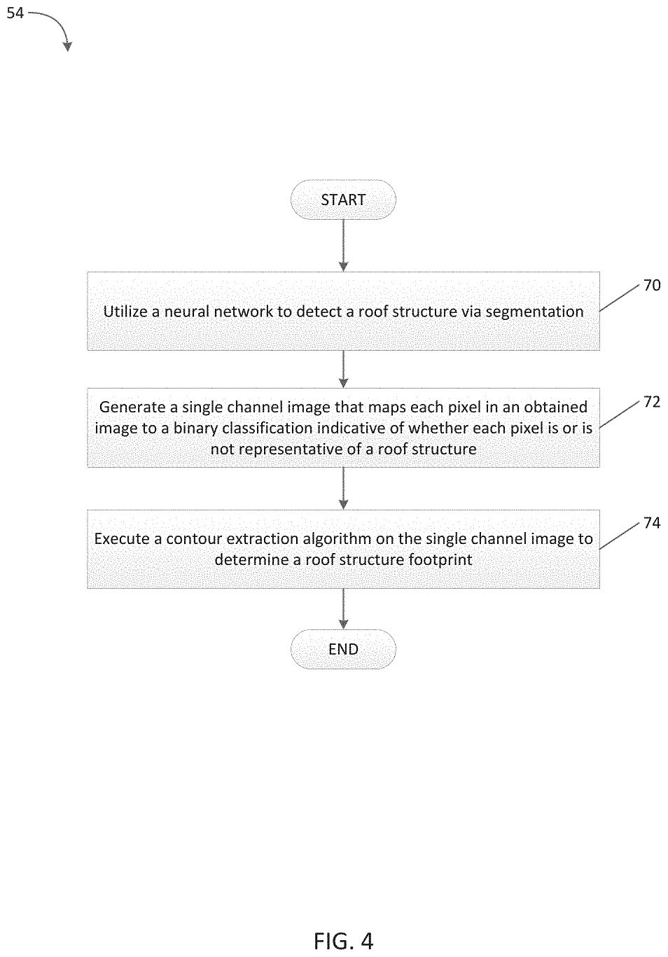

FIG. 4 is a flowchart illustrating step 54 of FIG. 2 in greater detail. In step 70, the system 10 utilizes a neural network to detect a roof structure present in the obtained image via segmentation. It should be understood that the system 10 can utilize any neural network which is trained to segment a roof structure. For example, the system 10 can utilize a Mask Region Based Convolutional Neural Network (R-CNN). Based on the neural network segmentation processing, in step 72, the system 10 generates a single channel image that maps each pixel in the obtained image to a binary classification indicative of whether each pixel is or is not representative of a roof structure. Then, in step 74, the system 10 executes a contour extraction algorithm on the single channel image to determine a footprint of the roof structure. In particular, the contour extraction algorithm determines pixel boundary locations of the roof structure. It should be understood that the system 10 can utilize any method suitable for determining the footprint of the roof structure present in the obtained image. For example, the system 10 can obtain a roof structure footprint from the roof structure footprint database 16. As mentioned above, the database 16 could store one or more three-dimensional representations of an imaged location (including structures at the location), such as point clouds, LiDAR files, etc., and the system 10 could operate with such three-dimensional representations. Alternatively, the system 10 can obtain a roof structure footprint supplied from a third-party source.

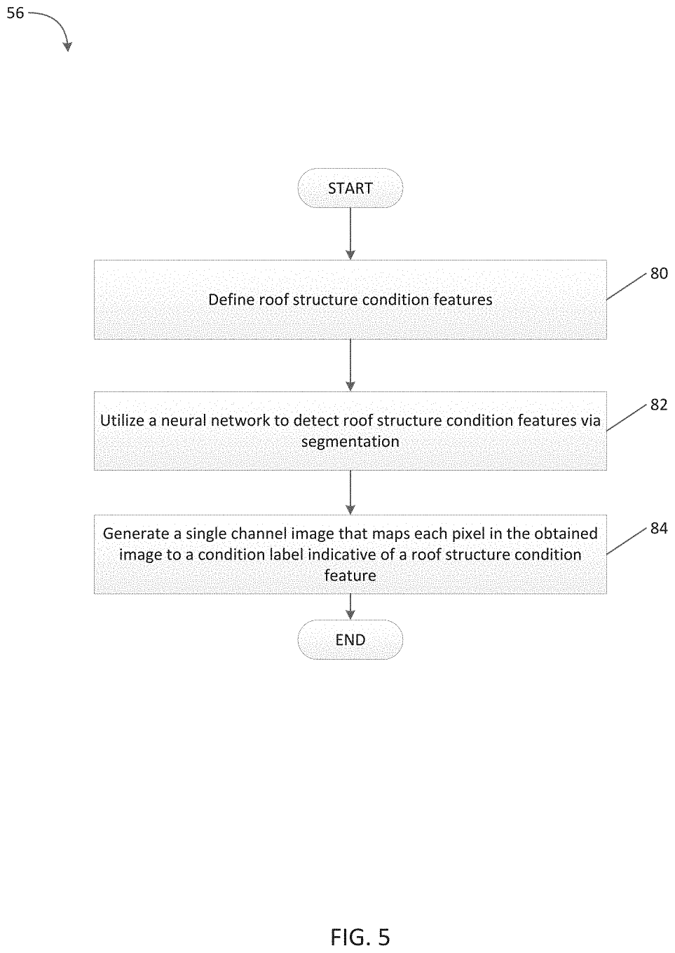

FIG. 5 is a flowchart illustrating step 56 of FIG. 2 in greater detail. As mentioned above, the system 10 identifies features of a roof structure that contribute to an overall condition of the roof structure. In step 80, the system defines these roof structure condition features. For example, the roof structure condition features can include, but are not limited to, discoloration, missing material (e.g., shingles), a tarp, debris (e.g., twigs, leaves, acorns, etc.), organic growth (e.g., moss and/or mold), a patch and/or repair, structural damage, and anomalies. In step 82, the system 10 utilizes a neural network to detect the roof structure condition features present in the obtained image via segmentation. It should be understood that the system 10 can utilize any neural network which is trained to segment roof structure condition features. For example, the system 10 can utilize a segmentation based neural network such as DeppLabV3 to segment the roof structure condition features. Based on the neural network segmentation processing, in step 84, the system 10 generates a single channel image that maps each pixel in the obtained image to a condition label indicative of a roof structure condition feature.

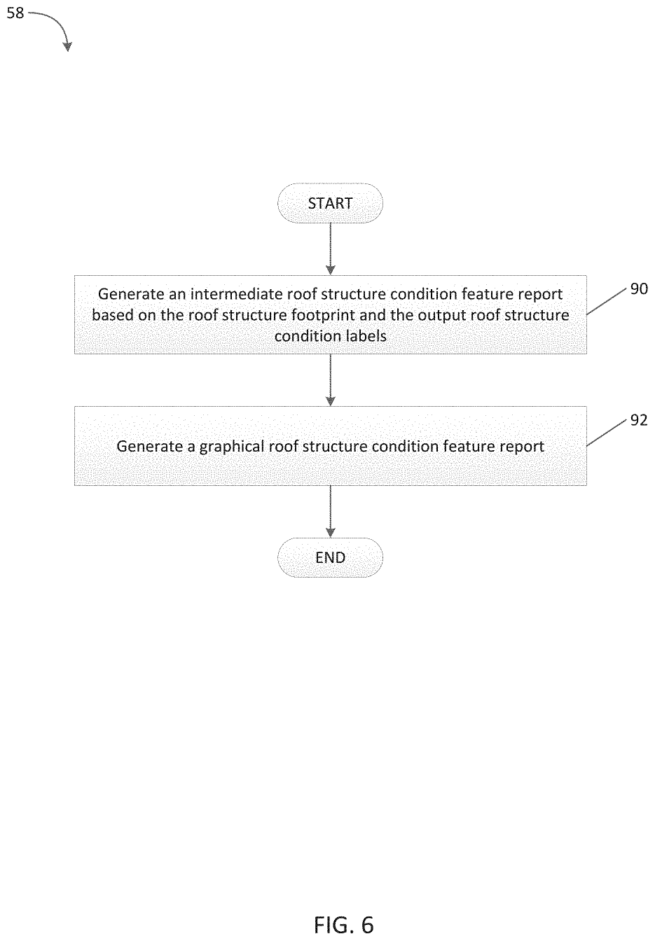

FIG. 6 is a flowchart illustrating step 58 of FIG. 2 in greater detail. In step 90, the system 10 generates an intermediate roof structure condition feature report based on the roof structure footprint and the condition labels. In particular, given the roof structure footprint and the mapping of each pixel to a condition label, the system 10 utilizes an algorithm to generate the intermediate roof structure condition feature report. For example, the system 10 can utilize the following algorithm:
Mask off condition labeled pixels utilizing the roof structure footprint pixels such that only pixels contained in the roof structure footprint are considered
For each class in a list of condition classes:
   Count=number of pixels with condition class label
   Total=number of pixels in roof structure footprint
   Class Percentage=Count/Total
   Report=All Class Percentages.

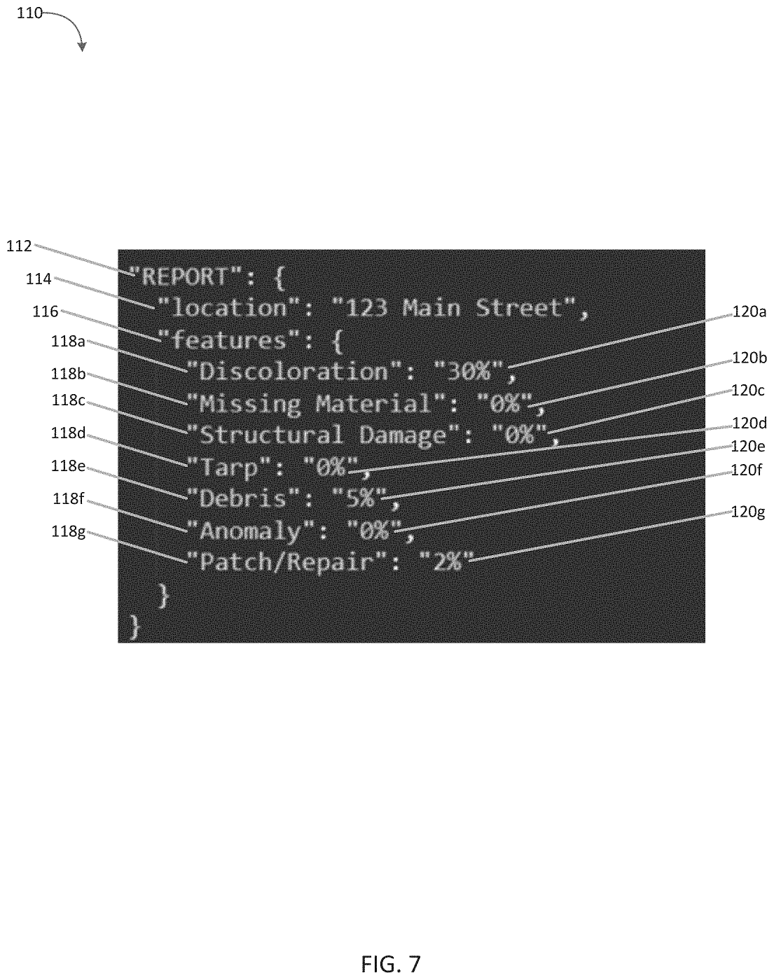

It should be understood that the system 10 can utilize any algorithm suitable for generating the intermediate roof structure condition feature report. For illustration, FIG. 7 shows a diagram 110 illustrating an intermediate roof structure condition feature report 112 generated by the system 10. As shown in FIG. 7, the intermediate roof structure condition feature report 112 can include a location 114 (e.g., an address) associated with a roof structure and roof structure features 116 including conditions thereof such as discoloration 118a, missing material 118b, structural damage 118c, a tarp 118d, debris 118e, an anomaly 118f, and a patch or repair 118g. Additionally, each condition 118a-g can include a corresponding percentage 120a-g indicative of the respective contributions of each condition 118a-g toward (percentages of composition of) the total roof structure. Additionally or alternatively, the system 10 can generate a score for each condition 118a-g indicative of a severity thereof. For example, the system 10 can generate a score from one to five corresponding to a decreasing severity (e.g., very poor, poor, fair, average, and excellent) of the condition.

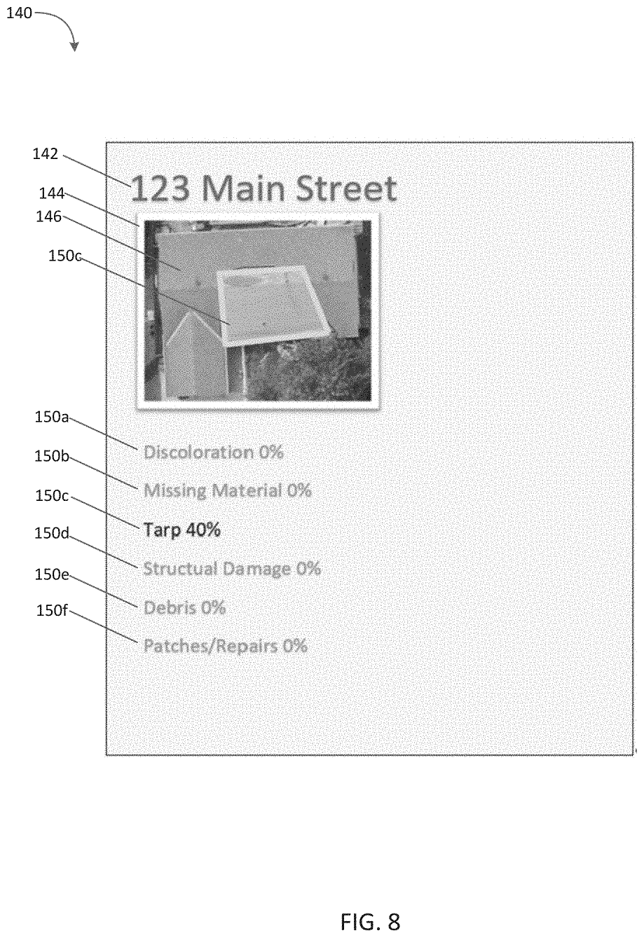

Referring back to FIG. 6, in step 92 the system 10 generates a graphical roof structure condition feature report. For illustration, FIG. 8 shows a diagram 140 illustrating a graphical roof structure condition feature report generated by the system 10. As shown in FIG. 8, the graphical roof structure condition feature report can include a location 142 (e.g., an address) associated with a roof structure 146 present in an obtained image 144 and roof structure condition features 150a-f including, but not limited to, discoloration 150a, missing material 150b, a tarp 150c, structural damage 150d, debris 150e, and a patch or repair 150f. Additionally, each condition 150a-f can include a corresponding percentage indicative of the respective contributions of each feature condition 150a-f toward (percentages of composition of) the total roof structure.

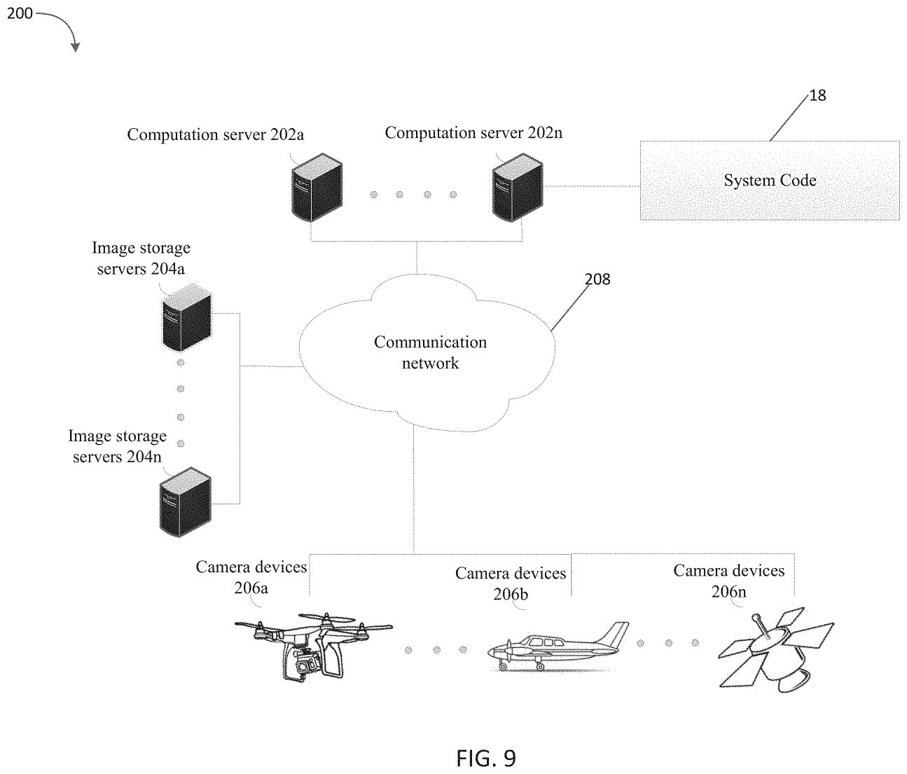

FIG. 9 a diagram illustrating another embodiment of the system 200 of the present disclosure. In particular, FIG. 9 illustrates additional computer hardware and network components on which the system 200 could be implemented. The system 200 can include a plurality of computation servers 202a-202n having at least one processor and memory for executing the computer instructions and methods described above (which could be embodied as system code 18). The system 200 can also include a plurality of image storage servers 204a-204n for receiving image data and/or video data. The system 200 can also include a plurality of camera devices 206a-206n for capturing image data and/or video data. For example, the camera devices can include, but are not limited to, an unmanned aerial vehicle 206a, an airplane 206b, and a satellite 206n. The computation servers 202a-202n, the image storage servers 204a-204n, and the camera devices 206a-206n can communicate over a communication network 208. Of course, the system 200 need not be implemented on multiple devices, and indeed, the system 200 could be implemented on a single computer system (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A computer vision system for determining a condition of a roof from an image, comprising:
an image database storing at least one image of a roof; and
a processor in communication with the image database, the processor:
retrieving the image of the roof from the database;
processing the image of the roof to determine a footprint of the roof;
determining at least one condition of the roof using a neural network; and
generating and transmitting a roof condition report indicating the at least one condition of the roof and a respective contribution of the at least one condition toward a total roof structure.

2. The system of claim 1, wherein the processor receives a geospatial region of interest (ROI) specified by a user and retrieves the image of the roof from the image database using the geospatial region of interest.

3. The system of claim 1, wherein the processor processes the image of the roof using neural network segmentation processing to generate a single channel image that maps each pixel in the image to a binary classification indicative of whether each pixel is or is not representative of a roof structure.

4. The system of claim 3, wherein the processor executes a contour extraction algorithm on the single channel image to determine the footprint of the roof structure.

5. The system of claim 4, wherein the contour extraction algorithm determines pixel boundary locations of the roof structure.

6. The system of claim 1, wherein the processor obtains the footprint of the roof from a roof structure footprint database in communication with the processor.

7. The system of claim 1, wherein the processor determines the at least one condition of the roof using a segmentation-based neural network that segments roof condition features.

8. The system of claim 7, wherein the processor generates a single channel image based on output of the segmentation-based neural network that maps each pixel in the image to a condition label indicative of the at least one condition of the roof.

9. The system of claim 1, wherein the respective contribution of the at least one condition toward the total roof structure comprises a percentage of composition of the total roof structure.

10. The system of claim 1, wherein the processor generates a score indicating a severity of the at least one condition and includes the score in the roof condition report.

11. A computer vision method for determining a condition of a roof from an image, comprising the steps of:
retrieving by a processor an image of a roof from an image database;
processing the image of the roof to determine a footprint of the roof;
determining at least one condition of the roof using a neural network executed by the processor; and
generating and transmitting a roof condition report indicating the at least one condition of the roof and a respective contribution of the at least one condition toward a total roof structure.

12. The method of claim 11, further comprising receiving by the processor a geospatial region of interest (ROI) specified by a user and retrieving the image of the roof from the image database using the geospatial region of interest.

13. The method of claim 11, further comprising segmentation processing by the processor the image of the roof to generate a single channel image that maps each pixel in the image to a binary classification indicative of whether each pixel is or is not representative of a roof structure.

14. The method of claim 13, further comprising executing by the processor a contour extraction algorithm on the single channel image to determine the footprint of the roof structure.

15. The method of claim 14, wherein the contour extraction algorithm determines pixel boundary locations of the roof structure.

16. The method of claim 11, further comprising obtaining by the processor the footprint of the roof from a roof structure footprint database in communication with the processor.

17. The method of claim 11, further comprising determining by the processor the at least one condition of the roof using a segmentation-based neural network that segments roof condition features.

18. The method of claim 17, further comprising generating by the processor a single channel image based on output of the segmentation-based neural network that maps each pixel in the image to a condition label indicative of the at least one condition of the roof.

19. The method of claim 11, wherein the respective contribution of the at least one condition toward the total roof structure comprises a percentage of composition of the total roof structure.

20. The method of claim 11, further comprising generating by the processor a score indicating a severity of the at least one condition and including the score in the roof condition report.
